(19) United States
(12) Patent Application Publication
(10) Pub. No.: US 2026/0264309 A1
(43) Pub. Date: Sep. 10, 2026

(54) Polyvinylpyrrolidone as Replacement for Fluorinated Polymer Processing Aids

(71) Applicant: Westlake Longview Corporation, Houston, TX (US)

(72) Inventor: Robert Louis ARECHEDERRA, Longview, TX (US)

(73) Assignee: Westlake Longview Corporation, Houston, TX (US)

(21) Appl. No.: 19/555,228

(22) Filed: Mar. 3, 2026

Related U.S. Application Data
(60) Provisional application No. 63/766,570, filed on Mar. 4, 2025.

(51) Int. Cl. B29C 49/04; B29K 23/00; B29K 71/00; B29K 105/00

(52) U.S. Cl. CPC B29C 49/04116; B29K 2023/0625; B29K 2039/00; B29K 2071/00; B29K 2105/0067

(57) ABSTRACT

Disclosed is a polymeric composition useful for making extruded products that can exhibit reduced melt fracture without the need to use perfluoroalkyl and polyfluoroalkyl substances (PFAS). The composition includes an ethylene-based polymer and a polymer processing aid containing polyvinylpyrrolidone (PVP). The PVP can effectively eliminate melt fracture without causing screw slip even at high loadings. The composition is particularly useful for making blown and cast films.

### CROSS-REFERENCE TO RELATED APPLICATION/PRIORITY CLAIM

Priority of U.S. Provisional Patent Application No. 63/766,570 filed on Mar. 4, 2025, is hereby claimed; the entire content of which is hereby incorporated by reference.

### FIELD OF THE INVENTION

The invention generally relates to polymeric compositions useful for forming extruded products with reduced melt fracture, and methods of making extruded products and methods of reducing melt fracture using the compositions.

### BACKGROUND OF THE INVENTION

Fluorinated materials have been used as processing aids in the polymer industry for decades. These materials eliminate die drool and surface imperfections in extruded resins. For professionals in the field, surface imperfections are typically known as melt fracture, tiger striping, or shark fin. Melt fracture in plastic film production, for example, can result in unreliable properties and poor appearance, making the film unsuitable for most uses.

Recently, fluorochemicals have become highly regulated, necessitating their replacement in many applications.

Some nonfluorinated compounds have been proposed as replacements for fluoropolymers. These alternatives, however, suffer from various shortcomings. For instance, polyethylene glycol (PEG) is a commonly used processing aid. But it requires a higher dosage to have an impact on melt fracture. Higher dosages of PEG, however, can increase screw slip, causing the extruder to fail in pumping the resin.

Another fluoropolymer alternative that has been proposed is siloxanes. These compounds, however, have an even more pronounced screw slip effect than PEG. They can also cause ink adhesion issues on plastic films intended for printing.

Thus, there is a need in the art for a suitable fluorochemical-free polymer processing aid, particularly one that is effective at eliminating melt fracture while not causing screw slip, even at higher loadings, and that will not adversely affect ink adhesion.

The present invention addresses this need as well as others, which will become apparent from the following description and the appended claims.

### SUMMARY OF THE INVENTION

The invention is as set forth in the appended claims.

Briefly, in one aspect, the present invention provides a composition comprising:
(a) an ethylene-based polymer; and
(b) a polymer processing aid (PPA) containing polyvinylpyrrolidone (PVP).
   The PVP is present in an amount effective to reduce or eliminate melt fracture in a product extruded from the composition relative to a product extruded under the same conditions and from a corresponding composition without the PVP.

The composition is particularly useful for making extruded products such as resin pellets, pipes, and blown and cast films. Thus, in a second aspect, the invention provides a method of making an extruded product. The method comprises the step of extruding a melt comprising the composition through a die.

In a third aspect, the invention provides a method of reducing melt fracture in an ethylene-based polymer product. The method comprises the step of adding a polymer processing aid (PPA) comprising polyvinylpyrrolidone (PVP) into an extrusion line containing an ethylene-based polymer to form a product. The PVP is added in an amount effective to reduce or eliminate melt fracture in the product relative to a product extruded under the same conditions and from the ethylene-based polymer without the PVP.

### BRIEF DESCRIPTION OF THE DRAWINGS

FIGS. 1-23 show optical microscopic images of the surface of the extruded ribbons formed in Examples 1-23, respectively.

### DETAILED DESCRIPTION OF THE INVENTION

It has been surprisingly discovered that polyvinylpyrrolidone (PVP) is very effective at eliminating melt fracture in polyethylene extruded products while not causing screw slip, even at higher loadings, and is fluorochemical free. In addition, since PVP is polar and, in some cases, an actual ingredient in ink formulations; it will not adversely affect ink adhesion.

Without wishing to be bound by theory, it is believed that when used as a processing aid in polymer processing, the PVP melts and migrates to the interface of the polymer and the processing equipment where it acts to reduce friction between the two. This effect primarily happens near the die, where the resin exits, allowing the PVP to lubricate at the melt fracture point rather than inside the screw pump, which would cause unwanted screw slip.

### Composition

Thus, in one aspect, the present invention provides a composition comprising:
(a) an ethylene-based polymer; and
(b) a polymer processing aid (PPA) comprising polyvinylpyrrolidone (PVP).

The amount of the ethylene-based polymer in the composition is not limited. The amount may range, for example, from 1 to 99 wt %, from 10 to 99 wt %, from 20 to 99 wt %, from 30 to 99 wt %, from 40 to 99 wt %, from 50 to 99 wt %, from 55 to 99 wt %, from 60 to 99 wt %, from 65 to 99 wt %, from 70 to 99 wt %, from 75 to 99 wt %, from 80 to 99 wt %, from 85 to 99 wt %, from 90 to 99 wt %, from 93 to 99 wt %, from 95 to 99 wt %, or from 97 to 99 wt %, based on the weight of the composition.

The PVP is present in the composition in an amount that is effective to reduce or eliminate melt fracture in a product extruded from the composition relative to a product extruded under the same conditions and from a corresponding composition without the PVP.

The amount of PVP suitable for achieving a reduction or elimination of melt fracture in the extruded product may vary over a wide range, but it can be determined by the ordinary skilled worker based on guidance provided herein. Generally, the PVP may be present in the composition in an amount ranging from 100 ppm to 10,000 ppm, from 100 ppm to 7,500 ppm, from 100 ppm to 5,000 ppm, from 100 ppm to 4,000 ppm, from 100 ppm to 3,000 ppm, from 250 to 10,000 ppm, from 250 to 7,500 ppm, from 250 to 5,000 ppm, from 250 to 4,000 ppm, from 250 to 3,000 ppm, from 500 to 10,000 ppm, from 500 to 7,500 ppm, from 500 to 5,000 ppm, from 500 to 4,000 ppm, from 500 to 3,000 ppm, from 750 to 10,000 ppm, from 750 to 7,500 ppm, from 750 to 5,000 ppm, from 750 to 4,000 ppm, from 750 to 3,000 ppm, from 1,000 to 10,000 ppm, from 1,000 to 7,500 ppm, from 1,000 to 5,000 ppm, from 1,000 to 4,000 ppm, or from 1,000 to 3,000 ppm, based on the weight of the composition.

In various embodiments, the PVP is used by itself as the PPA.

In various other embodiments, the PVP is used in combination with one or more other PPAs, such as PEG. In which case, the weight ratio of PVP to other PPAs in the composition can range from 99:1 to 1:99. Any and all ranges between 99:1 to 1:99 are contemplated and are disclosed herein, e.g., 75:25 to 25:75, 70:30 to 30:70, and 60:40 to 40:60.

If using a combination of PPAs is desired, the total amount of PPAs present in the composition can be such that it is effective to reduce or eliminate melt fracture in a product extruded from the composition relative to a product extruded under the same conditions and from a corresponding composition without the PPAs. In this scenario, the total amount of PPAs present in the composition may fall within the same general ranges described above, i.e., from 100 ppm to 10,000 ppm, based on the weight of the composition. Any and all ranges between 100 ppm and 10,000 ppm are contemplated and are disclosed herein, e.g., from 500 ppm to 5,000 ppm, from 1,000 ppm to 4,000 ppm, and from 1,500 ppm to 3,000 ppm.

As an example, in addition to PVP, the PPA may comprise PEG, such as from 40% to 60% by weight, based on the weight of the PPA.

It is also contemplated that combinations of PVPs with different characteristics, such as molecular weight, may be used as the PPA.

The composition may contain one or more additional additives in typical amounts. Examples of the additional additives include heat stabilizers, antioxidants, lubricants, antistatic agents, dispersants, plasticizers, flame retardants, viscosity enhancers, ultraviolet light absorbers, light stabilizers, slip agents, anti-blocking agents, dyes, pigments, and fillers.

The composition may be a concentrate/masterbatch or a fully formulated/compounded formulation.

The terms “masterbatch” and “concentrate” are used interchangeably. They refer to a composition that has a higher concentration of any component (e.g., the PPA) than a fully compounded or a fully formulated composition. The masterbatch can include a carrier resin. One or more of the ethylene-based polymers may be used as the carrier resin. The masterbatch is typically diluted with a letdown resin to form the fully formulated composition. One or more of the ethylene-based polymers may be used as the letdown resin. The letdown resin may be the same or different polymer than the carrier resin. The masterbatch can be formed by dry mixing and/or melt blending the components. The fully formulated composition is what is used to form a shaped object, such as a film.

In the case of a masterbatch, the composition may contain from 1% to 50%, or more, by weight of the PPA, based on the weight of the composition.

The composition may be prepared by melt blending the ingredients by any suitable method, such as by single-screw extrusion, co- or counter-rotating twin-screw extrusion, batch mixers, and any combination thereof. The ingredients may be introduced in the form of pellet, shred, grind, regrind, fluff, scrap, or any combination thereof.

The composition may also be in the form of resin pellets, a pipe, a blown film, or a cast film.

In various embodiments, the composition is free of an added perfluoroalkyl or polyfluoroalkyl substance (PFAS).

### Ethylene-Based Polymer

The terms “ethylene-based polymer” and “polyethylene” are used interchangeably herein. They refer to a polymer that contains more than 50 weight percent of polymerized ethylene monomer (based on the total amount of polymerizable monomers) and, optionally, may contain at least one comonomer. Ethylene-based polymer includes ethylene homopolymer and ethylene copolymers (meaning units derived from ethylene and one or more comonomers). Examples of ethylene-based polymer (polyethylene) include high-density polyethylene (HDPE), low-density polyethylene (LDPE), linear low-density polyethylene (LLDPE), very-low-density polyethylene (VLDPE), VLDPE with long branches, and ultra-low-density polyethylene (ULDPE) (also known as plastomers).

The polyethylene may have a density ranging from 0.850 to 0.970 g/cm³. Any and all ranges between 0.850 to 0.970 g/cm3 are contemplated and are disclosed herein, e.g., from 0.850 to 0.960 g/cm³, from 0.850 to 0.950 g/cm³, from 0.850 to 0.940 g/cm³, from 0.850 to 0.930 g/cm³, from 0.850 to 0.925 g/cm³, from 0.850 to 0.920 g/cm³, from 0.880 to 0.970 g/cm³, from 0.880 to 0.960 g/cm³, from 0.880 to 0.950 g/cm³, from 0.880 to 0.940 g/cm³, from 0.880 to 0.930 g/cm³, from 0.880 to 0.925 g/cm³, from 0.880 to 0.920 g/cm³, from 0.900 to 0.970 g/cm³, from 0.900 to 0.960 g/cm³, from 0.0900 to 0.950 g/cm³, from 0.900 to 0.940 g/cm³, from 0.900 to 0.930 g/cm³, from 0.900 to 0.925 g/cm³, or from 0.900 to 0.920 g/cm³.

Generally, polyethylene may be produced in gas-phase, fluidized-bed reactors; liquid-phase, slurry process reactors; or liquid-phase, solution process reactors, using a heterogeneous catalyst system, such as Ziegler-Natta catalyst; a homogeneous catalyst system comprising Group 4 transition metals; and ligand structures, such as metallocene, non-metallocene metal-centered, heteroaryl, heterovalent aryloxyether, phosphine-imine, and others. Combinations of heterogeneous and/or homogeneous catalysts may also be used in either single-reactor or dual-reactor configurations.

In various embodiments, the ethylene-based polymer includes HDPE, LDPE, LLDPE, VLDPE, ULDPE, or combinations thereof.

In various embodiments, the ethylene-based polymer includes LLDPE.

In various embodiments, the LLDPE is a Ziegler-Natta-catalyzed LLDPE, a metallocene-catalyzed LLDPE, or combinations thereof.

In various embodiments, the ethylene-based polymer has a melt index (I₂) of 0.01 to 50 g/10 minutes, of 0.01 to 40 g/10 minutes, of 0.01 to 30 g/10 minutes, of 0.01 to 20 g/10 minutes, of 0.01 to 15 g/10 minutes, of 0.01 to 10 g/10 minutes, or of 0.01 to 5 g/10 minutes (measured according to ASTM D1238 at Condition 190/2.16).

### Polyvinylpyrrolidone (PVP)

Polyvinylpyrrolidone (CAS Number 9003-39-8) (known as PVP or various tradenames such as Kollidon® and Povidone) is used widely in many different industries. In pharmaceuticals, it is used as an excipient and a time-release matrix for active drug components. It also finds use as a lubricating agent in water-based eye drops and as an iodine complexing agent for surgical disinfectants. In other industries, it is used as a water-soluble thickener, a surfactant, a water-based adhesive, and even as a stabilizer in food known as (E number E1201).

Since PVP is widely used in the pharmaceutical industry, its toxicology is well understood and is considered nontoxic. This makes PVP an ideal material to be considered as a processing aid for plastic materials that will be used in food contact applications.

PVP is the polymer of vinyl pyrrolidone, and it is widely available in many different molecular weights and molecular weight distributions. It is also available with varying degrees of crosslinking known as crospovidone. While PVP is a very different polymer from PPAs such as PEG and polyvinylidene fluoride (PVDF), it does share some physical properties with PEG, such as water solubility, surfactant qualities, and lubrication.

In various embodiments, the PVP for use in the present invention may have a weight-average molecular weight (M_{w}) of 1,000 to 100,000 g/mol, of 1,000 to 75,000 g/mol, of 1,000 to 50,000 g/mol, of 1,000 to 40,000 g/mol, of 1,000 to 30,000 g/mol, of 1,000 to 20,000 g/mol, of 1,000 to 10,000 g/mol, of 1,000 to 5,000 g/mol, of 1,000 to 4,000 g/mol, of 1,000 to 3,000 g/mol, of 1,000 to 2,000 g/mol, of 1,500 to 100,000 g/mol, of 1,500 to 75,000 g/mol, of 1,500 to 50,000 g/mol, of 1,500 to 40,000 g/mol, of 1,500 to 30,000 g/mol, of 1,500 to 20,000 g/mol, of 1,500 to 10,000 g/mol, of 1,500 to 5,000 g/mol, of 1,500 to 4,000 g/mol, of 1,500 to 3,000 g/mol, of 1,500 to 2,000 g/mol, of 2,000 to 100,000 g/mol, of 2,000 to 75,000 g/mol, of 2,000 to 50,000 g/mol, of 2,000 to 40,000 g/mol, of 2,000 to 30,000 g/mol, of 2,000 to 20,000 g/mol, of 2,000 to 10,000 g/mol, of 2,000 to 5,000 g/mol, of 2,000 to 4,000 g/mol, of 2,000 to 3,000 g/mol, of 7,000 to 11,000 g/mol, of 28,000 to 34,000 g/mol, or of 44,000 to 54,000 g/mol.

PVPs with lower molecular weights tend to have a greater melt fracture reducing effect, such as those with a M_{w} of 1,000 to 10,000 g/mol, of 1,000 to 5,000 g/mol, of 1,000 to 4,000 g/mol, of 1,000 to 3,000 g/mol, or of 2,000 to 3,000 g/mol.

Combinations of PVPs (e.g., those with different molecular weights and/or molecular weight distributions) may be used as the polymer processing aid.

### Polyethylene Glycol (PEG)

PEG is a very good processing aid for reducing melt fracture during plastic processing but suffers some limitations with loading. In general, PEG can be used up to 1,000 ppm in most common single-screw extruders, but beyond this threshold, it causes a phenomenon known as screw slip where the lubrication between the resin melt and the interior of the equipment becomes too great and the equipment fails to pump the resin. This limit also means that if the PEG at 1,000 ppm does not clear the melt fracture, then there are limited options to achieve a quality product. In this case, reducing the pumping rate of the resin is typically required, which significantly raises the cost of the final product.

In accordance with the invention, PVP offers the added benefit of being combinable with PEG, allowing for a reduced PEG load when its use is desired.

Thus, as noted above, in various embodiments, the PPA further comprises PEG.

The PEG may have a weight-average molecular weight ranging from 4,000 to 15,000 g/mol, from 6,000 to 13,000 g/mol, or from 8,000 to 11,000 g/mol.

Suitable PEGs may be obtained commercially.

### Method of Making Extruded Product

The compositions according to the invention are particularly suited for making extruded products, such as resin pellets, pipes, blown films, and cast films.

Thus, in a second aspect, the invention provides a method of making an extruded product. The method includes the step of extruding a melt of the compositions of the invention through a die.

In the extrusion step, resin pellets (or other suitable forms of the ingredients) are typically gravity fed into a heated barrel of an extruder. The pellets are conveyed down the barrel by a screw that first compacts and then melts the pellets through shear-induced heat. The last section of the screw, also known as the metering section, ensures a homogeneous melt and uniform output.

In the case of blown films, the polymer melt is forced through a tubular-shaped (or annular) die. After exiting the die, the molten tube of polymer is injected with air and generally pulled upward by a set of nip rolls, although in some cases, it can be pulled horizontally or downward. As film thickness is reduced, the tube expands because of internal bubble pressure and forms a tube of larger diameter. Air rings aid in film cooling by supplying air flow around the molten tube. The tube is then drawn down to a desired final film thickness, for example, in the range of 5 to 250 μm, or from 10 to 125 μm.

In the case of cast films, the polymer melt is extruded through a flat sheet extrusion die (often referred to as a “flat die”). The flat die may have various designs, such as “keyhole,” “T-shaped,” or “coat hanger.” The molten sheet of polymer (cast film) is usually extruded downward, but in some cases, can be extruded horizontally. Within inches after exiting the die, the sheet is deposited onto a rotating chilled roller where the melt is cooled and solidified. An air knife can be used in conjunction with the chill roller to expedite cooling. The chill roller can be polished smooth, have a matte finish, or be embossed with a repeating pattern. Following quenching, the film can go over a nip roll before being wound at a winding station. Film edges are usually trimmed, chopped, and re-introduced into the system as flaky material called “fluff” or “regrind.” The film thickness can be reduced at the nip roll. Thickness can also be controlled by altering the winder speed and the nip tension. The film can be subjected to lateral draw with the use of drawing pins to a desired final film thickness. Film thicknesses can range, for example, in the range of 5 to 250 μm, or from 10 to 125 μm.

In the case of resin pellets, the melt may be forced through a die and then to a plastic pelletizer (also known as a plastic granulator). The pelletizer is a machine that turns the melt into small pellets. There are three types of pelletizers are available in the market: (1) underwater pelletizers; (2) water-ring pelletizer; and (3) strand pelletizers. Depending on the type of pelletizer used, the pellet shapes can range from spherical to rounded but flat, to cylindrical.

In the case of pipes, the extruder converts the composition into a continuous tubular melt by extrusion through an annular die. The molten pipe then proceeds through a sizing or calibration bench (which adjust its dimensions) to a cooling tank. After being cooled, the pipe passes via a haul-off to the cutting machine, for cutting it into final lengths, or coiling.

### Method of Reducing Melt Fracture

In a third aspect, the invention provides a method of reducing melt fracture in an ethylene-based polymer product. The method comprises the step of adding a polymer processing aid (PPA) comprising polyvinylpyrrolidone (PVP) into an extrusion line comprising an ethylene-based polymer to form a product.

The PVP is used in an amount effective to reduce or eliminate melt fracture in the product relative to a product extruded under the same conditions and from the ethylene-based polymer without the PVP.

The PPA, PVP, ethylene-based polymer, and extruded product may be as described above.

The main components of an extrusion line include (1) an extruder, (2) a die head, (3) a cooling system, (4) haul-off equipment, (5) cutting equipment, and (6) winding equipment. These components are briefly discussed below.

### Extruder

The extruder is the core equipment of the entire line and is responsible for heating and melting the composition ingredients and extruding the mixture through the die head into the desired shape. The extruder usually includes a screw, a heating zone, a cooling zone, a motor, and a control system. The screw is responsible for heating and pushing the plastic pellets to melt and form a uniform molten material.

### Die Head

The die head is the component that molds the molten composition into a specific cross-sectional shape. Its design and construction determine the shape and size of the final product. The die head can contain multiple extrusion holes through which the molten plastic is extruded to form the initial product shape.

### Cooling System

A cooling system is used to rapidly cool and cure the extruded molten product to maintain its desired shape and size. Cooling systems can include components such as water showers or baths, cold air blowers, and cooling rollers to ensure that the product cools quickly and remains stable after extrusion.

### Haul-Off Equipment

Haul-off equipment is used to pull the extruded product from the die head and to control the product's haul-off speed to ensure consistent size and appearance. Haul-off equipment typically includes belts, straps, and/or tires to provide consistent traction.

### Cutting Equipment

Cutting equipment is used to cut the extruded product to the desired length. Cutting can be done with knives, saws, blades, etc., to ensure that each product is the desired size.

### Winding Equipment

Finally, to produce films and long pipes, winding equipment is used to wind the extruded product into coils for easy transport and storage.

### General Provisions

To remove any doubt, the present invention includes and expressly contemplates and discloses any and all combinations of embodiments, features, characteristics, parameters, and/or ranges mentioned herein. That is, the subject matter of the present invention may be defined by any combination of embodiments, features, characteristics, parameters, and/or ranges mentioned herein.

It is contemplated that any ingredient, component, or step that is not specifically named or identified as part of the present invention may be explicitly excluded.

Any process/method, apparatus, compound, composition, embodiment, or component of the present invention may be modified by the transitional terms “comprising,” “consisting essentially of,” or “consisting of,” or variations of those terms.

As used herein, the indefinite articles “a” and “an” mean one or more, unless the context clearly suggests otherwise. Similarly, the singular form of nouns includes their plural form, and vice versa, unless the context clearly suggests otherwise.

While attempts have been made to be precise, the numerical values and ranges described herein may be considered approximations. These values and ranges may vary from their stated numbers depending upon the desired properties sought to be obtained by the present disclosure as well as the variations resulting from the standard deviation found in the measuring techniques. Moreover, the ranges described herein are intended and specifically contemplated to include all sub-ranges and values within the stated ranges. For example, a range of 50 to 100 is intended to include all values within the range including sub-ranges such as 60 to 90, 70 to 80, etc.

Any two numbers of the same property or parameter reported in the working examples may define a range. Those numbers may be rounded off to the nearest thousandth, hundredth, tenth, whole number, ten, hundred, or thousand to define the range.

The content of all documents cited herein, including patents as well as non-patent literature, is hereby incorporated by reference in their entirety. To the extent that any incorporated subject matter contradicts with any disclosure herein, the disclosure herein shall take precedence over the incorporated content.

This invention can be further illustrated by the following working examples, although these examples are included merely for purposes of illustration and are not intended to limit the scope of the invention.

### EXAMPLES

### Experimental Setup

A Brabender torque rheometer with a single-screw extruder attachment and a 25.4-mm wide ribbon die was used to prepare extruded ribbons for the following examples.

### Extruder Conditions

The extruder zones were set at 220° C. The extruder drive was set to 30 RPM (revolutions per minute) which displayed 100% melt fracture of the base resin when no processing aid was used (Example 1).

### Materials

The materials used to prepare the ribbons in the examples are listed in Table 1 below.

TABLE 1

| Polymer | Description |
|---|---|
| Base Resin | LLDPE (hexene-based) with a density of |
| | 0.917 g/cm³ and a melt index of 0.50 g/10 |
| | minutes (Condition 190° C./2.16 kg) |
| Polymer | Kynarflex ® 3120-50 - |
| Processing | a polyvinylidene fluoride (PVDF) with a melt flow rate of |
| Aid (PPA) 1 | 2.5-7.5 g/10 minutes (Condition 235° C./5 kg) |
| PPA 2 | Kollidon ® 12 PF - |
| | a polyvinylpyrrolidone with a M_{w} of 2000-3000 AMU |
| PPA 3 | Kollidon ® 17 PF - |
| | a polyvinylpyrrolidone with a M_{w} of 7000-11000 AMU |
| PPA 4 | Kollidon ® 30 - |
| | a polyvinylpyrrolidone with a M_{w} of 44000-54000 AMU |
| PPA 5 | Polyethylene glycol (PEG) with a M_{w} of 8000 Da |

### Examples 1-23

For each example, the base resin and, if applicable, polymer processing aid (PPA) were melted blended and extruded using the experimental setup and extruder conditions described above to form an extruded ribbon.

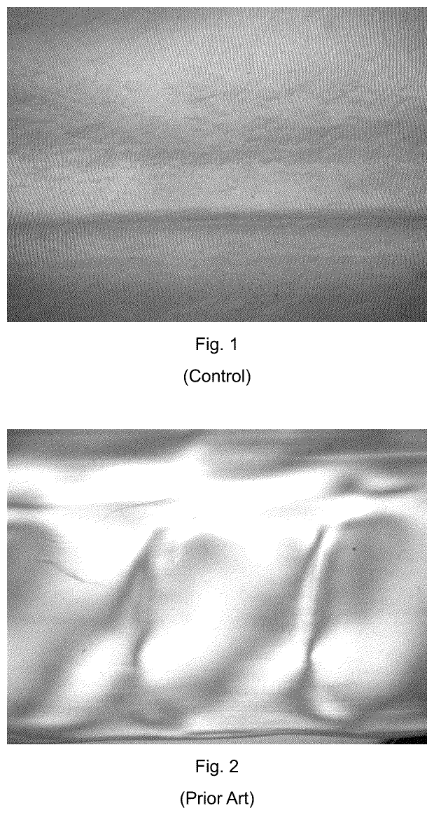

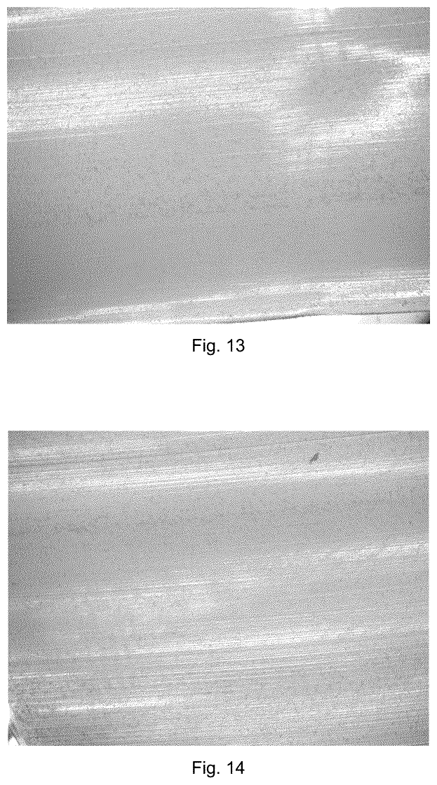

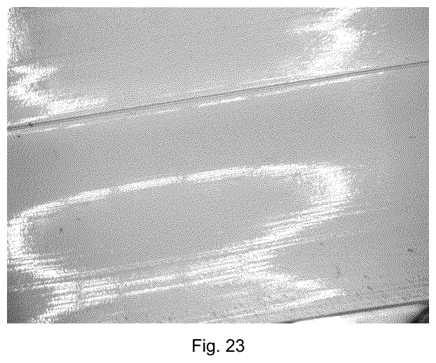

The surface of each ribbon was captured and examined under a Keyence VHX-2000E digital microscope with lens VH-Z20R/W/T at 20× zoom. Micrographs of the surface of each ribbon are shown in FIGS. 1-23.

The type and amount of PPA used in each example are reported in Table 3 below, along with the degree of melt fracture observed under the digital microscope after 60 minutes of extrusion.

The degree of melt fracture of each ribbon was also graded on a scale of A to F. The meaning of each letter grade is listed in Table 2 below.

TABLE 2

| Letter Grade | Meaning |
|---|---|
| A | No or nearly no melt fracture observed. |
| B | Minor amount of melt fracture observed. |
| C | Moderate amount of melt fracture observed. |
| D | Significant amount of melt fracture observed. |
| F | Extreme amount of melt fracture observed. |

The letter grades for each ribbon are also reported in Table 3.

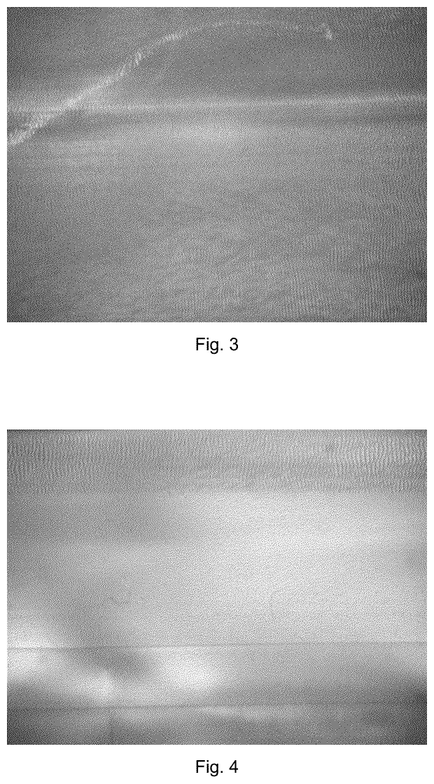

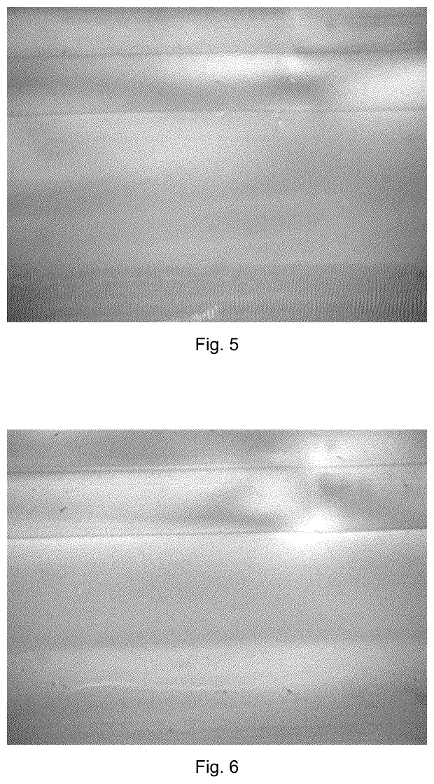

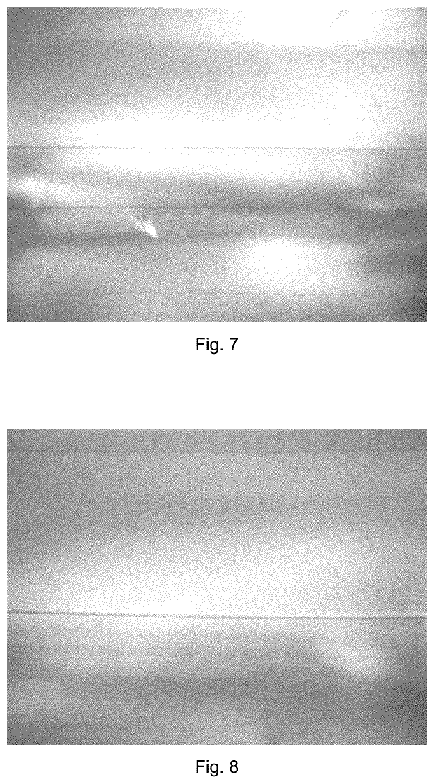

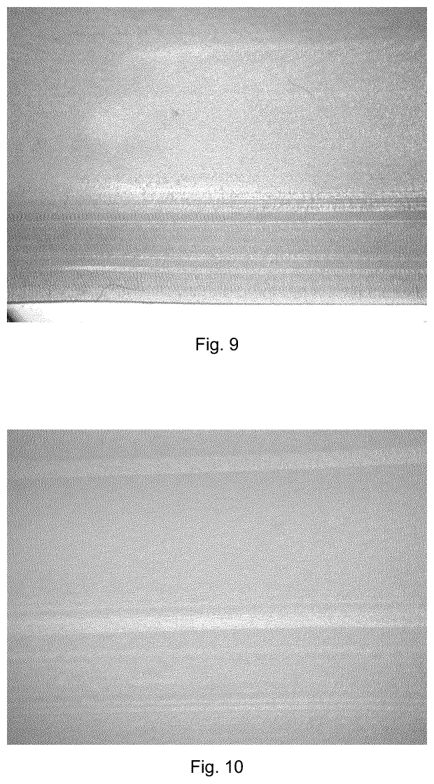

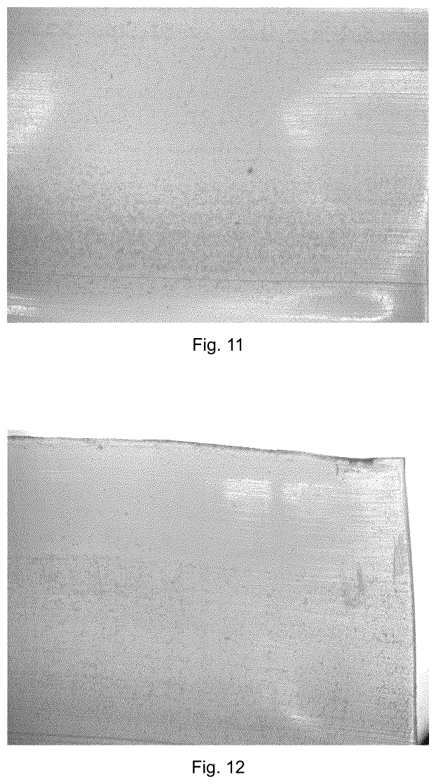

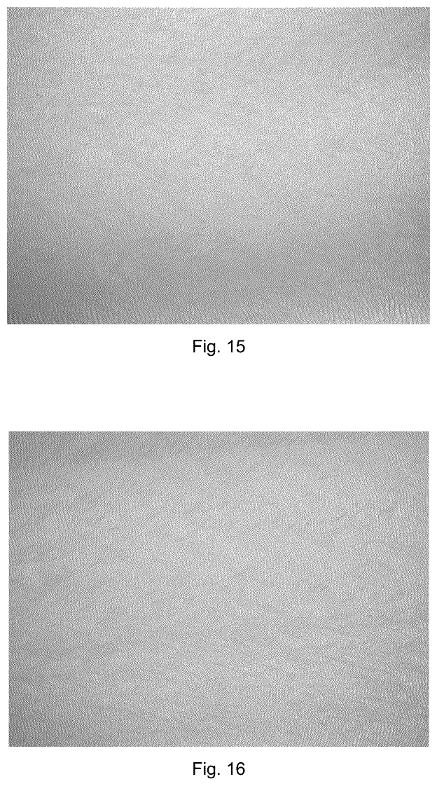

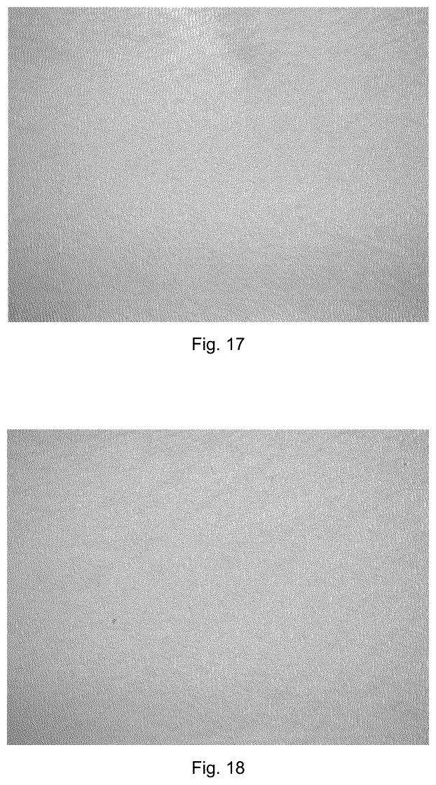

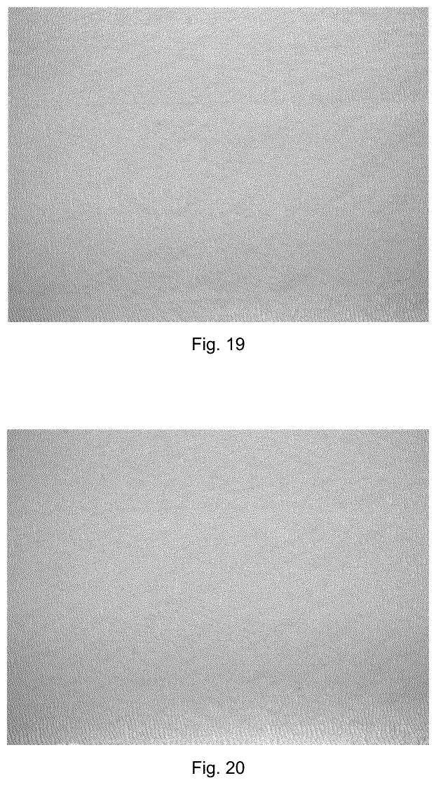

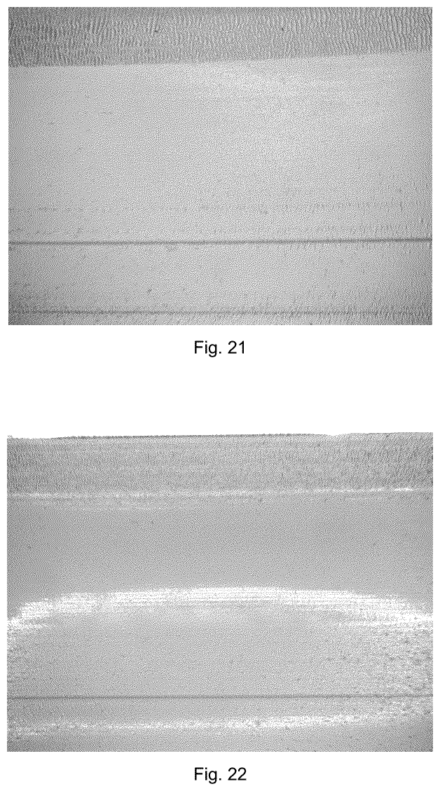

TABLE 3

| | Polymer Processing Aid | | | | | Observation | |
|---|---|---|---|---|---|---|---|
| | PVDF | Polyvinylpyrrolidone | | | PEG | After 60 | Ribbon |
| Example | PPA 1 | PPA 2 | PPA 3 | PPA 4 | PPA 5 | Minutes of | Surface |
| No. | (ppm) | (ppm) | (ppm) | (ppm) | (ppm) | Extrusion | Appearance |
| 1 (Control) | 0 | 0 | 0 | 0 | 0 | Striations of | F |
| | | | | | | severe melt | |
| | | | | | | fracture. See | |
| | | | | | | FIG. 1. | |
| 2 (Prior | 800 | 0 | 0 | 0 | 0 | Melt fracture | A |
| Art) | | | | | | reduced to near | |
| | | | | | | zero. See FIG. 2. | |
| 3 | 0 | 500 | 0 | 0 | 0 | Some reduction | F |
| | | | | | | of melt fracture. | |
| | | | | | | See FIG. 3. | |
| 4 | 0 | 1000 | 0 | 0 | 0 | Some reduction | D |
| | | | | | | of melt fracture. | |
| | | | | | | See FIG. 4. | |
| 5 | 0 | 1500 | 0 | 0 | 0 | Moderate | C |
| | | | | | | reduction of melt | |
| | | | | | | fracture. See | |
| | | | | | | FIG. 5. | |
| 6 | 0 | 2000 | 0 | 0 | 0 | Significant | B |
| | | | | | | reduction of melt | |
| | | | | | | fracture. See | |
| | | | | | | FIG. 6. | |
| 7 | 0 | 2500 | 0 | 0 | 0 | Complete | A |
| | | | | | | elimination of | |
| | | | | | | melt fracture. | |
| | | | | | | See FIG. 7. | |
| 8 | 0 | 3000 | 0 | 0 | 0 | Complete | A |
| | | | | | | elimination of | |
| | | | | | | melt fracture. | |
| | | | | | | See FIG. 8. | |
| 9 | 0 | 0 | 500 | 0 | 0 | Some reduction | F |
| | | | | | | of melt fracture. | |
| | | | | | | See FIG. 9. | |
| 10 | 0 | 0 | 1000 | 0 | 0 | Some reduction | D |
| | | | | | | of melt fracture. | |
| | | | | | | See FIG. 10. | |
| 11 | 0 | 0 | 1500 | 0 | 0 | Moderate | C |
| | | | | | | deduction of melt | |
| | | | | | | fracture. See | |
| | | | | | | FIG. 11. | |
| 12 | 0 | 0 | 2000 | 0 | 0 | Significant | B |
| | | | | | | reduction of melt | |
| | | | | | | fracture. See | |
| | | | | | | FIG. 12. | |
| 13 | 0 | 0 | 2500 | 0 | 0 | Melt fracture | A |
| | | | | | | reduced to near | |
| | | | | | | zero. See FIG. | |
| | | | | | | 13. | |
| 14 | 0 | 0 | 3000 | 0 | 0 | Melt fracture | A |
| | | | | | | reduced to near | |
| | | | | | | zero. See FIG. | |
| | | | | | | 14. | |
| 15 | 0 | 0 | 0 | 500 | 0 | Severe melt | F |
| | | | | | | fracture. See | |
| | | | | | | FIG. 15. | |
| 16 | 0 | 0 | 0 | 1000 | 0 | Severe melt | F |
| | | | | | | fracture. See | |
| | | | | | | FIG. 16. | |
| 17 | 0 | 0 | 0 | 1500 | 0 | Severe melt | F |
| | | | | | | fracture. See | |
| | | | | | | FIG. 17. | |
| 18 | 0 | 0 | 0 | 2000 | 0 | Severe melt | F |
| | | | | | | fracture. See | |
| | | | | | | FIG. 18. | |
| 19 | 0 | 0 | 0 | 2500 | 0 | Severe melt | F |
| | | | | | | fracture. See | |
| | | | | | | FIG. 19. | |
| 20 | 0 | 0 | 0 | 3000 | 0 | Severe melt | F |
| | | | | | | fracture. See | |
| | | | | | | FIG. 20. | |
| 21 | 0 | 500 | 0 | 0 | 500 | Moderate | C |
| | | | | | | reduction of melt | |
| | | | | | | fracture. See | |
| | | | | | | FIG. 21. | |
| 22 | 0 | 1000 | 0 | 0 | 1000 | Significant | B |
| | | | | | | reduction of melt | |
| | | | | | | fracture. See | |
| | | | | | | FIG. 22. | |
| 23 | 0 | 1500 | 0 | 0 | 1500 | Melt fracture | A |
| | | | | | | reduced to near | |
| | | | | | | zero. See FIG. | |
| | | | | | | 23. | |

As seen from FIGS. 3-20, all the PVPs tested reduced melt fracture in the extruded ribbon. PPA 2 (Kollidon® 12 PF), which had the lowest molecular weight, showed the most melt fracture reducing effect.

The combination of PVP with PEG (Examples 21-23) also reduced melt fracture in the extruded ribbon, but some screw slip was observed with higher PEG loadings.

During extrusion, it was noted that even at the highest concentration of PVP, no screw slip was observed.

The invention has been described in detail with particular reference to preferred embodiments thereof, but it will be understood that variations and modifications can be made within the spirit and scope of the invention.

I claim:

1. A composition comprising:
(a) an ethylene-based polymer; and
(b) a polymer processing aid (PPA) comprising polyvinylpyrrolidone (PVP),
wherein the PVP is present in an amount effective to reduce or eliminate melt fracture in a product extruded from the composition relative to a product extruded under the same conditions and from a corresponding composition without the PVP.

2. The composition of claim 1, wherein the ethylene-based polymer has a density of 0.850 to 0.970 g/cm³.

3. The composition of claim 1, wherein the ethylene-based polymer comprises high-density polyethylene (HDPE), low-density polyethylene (LDPE), linear low-density polyethylene (LLDPE), very-low-density polyethylene (VLDPE), ultra-low-density polyethylene (ULDPE), or combinations thereof.

4. The composition of claim 1, wherein the ethylene-based polymer has a melt index of 0.01 to 50 g/10 minutes.

5. The composition of claim 1, wherein the ethylene-based polymer comprises LLDPE.

6. The composition of claim 5, wherein the LLDPE is a Ziegler-Natta-catalyzed LLDPE, a metallocene-catalyzed LLDPE, or combinations thereof.

7. The composition of claim 1, wherein the PVP is present in an amount ranging from 100 ppm to 10,000 ppm, based on the weight of the composition.

8. The composition of claim 1, wherein the PVP has a weight-average molecular weight (M_{w}) of 1,000 to 100,000 g/mol.

9. The composition of claim 1, wherein the ethylene-based polymer comprises LLDPE, and wherein the PVP has a M_{w} of 2,000 to 3,000 g/mol.

10. The composition of claim 1, wherein the PPA further comprises polyethylene glycol (PEG).

11. The composition of claim 10, wherein the PPA comprises from 40% to 60% by weight of PEG, based on the weight of the PPA.

12. The composition of claim 1, which is a masterbatch comprising from 1% to 50% by weight of the PPA, based on the weight of the composition.

13. The composition of claim 1, which is free of an added perfluoroalkyl or polyfluoroalkyl substance.

14. The composition of claim 1, which is in the form of resin pellets, a pipe, a blown film, or a cast film.

15. A method of making an extruded product, the method comprising extruding a melt comprising the composition of claim 1 through a die.

16. A method of reducing melt fracture in an ethylene-based polymer product, the method comprising:
adding a polymer processing aid (PPA) comprising polyvinylpyrrolidone (PVP) into an extrusion line comprising an ethylene-based polymer to form a product,
wherein the PVP is added in an amount effective to reduce or eliminate melt fracture in the product relative to a product extruded under the same conditions and from the ethylene-based polymer without the PVP.

17. The method of claim 16, wherein the PPA is added as a masterbatch.

18. The method of claim 1, wherein the ethylene-based polymer comprises LLDPE, and wherein the PVP has a M_{w} of 2,000 to 3,000 g/mol.

19. The method of claim 1, wherein the PPA further comprises polyethylene glycol (PEG).

20. The method of claim 1, wherein the PPA is free of an added perfluoroalkyl or polyfluoroalkyl substance.
